(19) United States
(12) Patent Application Publication
(10) Pub. No.: US 2021/0264715 A1
(43) Pub. Date: Aug. 26, 2021

(54) VENDING MACHINE AND MERCHANDISE OUTPUT METHOD THEREOF

(71) Applicants: WEIHAI NEW BEIYANG DIGITAL TECHNOLOGY CO., LTD., Shandong (CN); SHANDONG NEW BEIYANG INFORMATION TECHNOLOGY CO., LTD., Shandong (CN)

(72) Inventors: Chunguang ZHANG, Shandong (CN); Chong ZHOU, Shandong (CN); Jiansong LIU, Shandong (CN); Tianxin JIANG, Shandong (CN); Chuntao WANG, Shandong (CN)

(21) Appl. No.: 17/255,197

(22) PCT Filed: Jun. 20, 2019
(86) PCT No.: PCT/CN2019/092068

§ 371 Date: Dec. 22, 2020

(30) Foreign Application Priority Data
Jun. 25, 2018 (CN) 201810664919.9

(51) Int. Cl. G07F 11/16

(52) U.S. Cl. CPC G07F 11/1653; G07F 11/163

(57) ABSTRACT

Provided are a vending machine and a merchandise dispensing method thereof. A merchandise dispensing method comprising: driving the gate to move from a closed position to an open position and driving the receiving bin to rotate from a receiving position to a dispensing position in the case where a bucket containing the commodity for sale is located at a pickup port; when a baffle is inserted into the pickup port, the baffle and the gate move simultaneously, and the spacing between them is always less than or equal to a first preset value.

This application claims the priority of Chinese patent application No. 201810664919.9, which was filed with the China National Intellectual Property Administration on Jun. 25, 2018 and the entirety of which is incorporated herein by reference.

### TECHNICAL FIELD

This application relates to the technical field of automatic vending, such as a vending machine and a merchandise dispensing method thereof.

### BACKGROUND

The vending machine is a commercial automation device used for automatic sales of commodities. Vending machines are more and more widely used, as they have advantages of no time and place restrictions, manpower reduction and easy transactions.

A vending machine is disclosed in the related art. The vending machine includes a cabinet body and a control device. A pickup port is arranged at the surface of the cabinet body and provided with a gate for its blocking or opening. Storage columns and a bucket are arranged in the cabinet body. The storage columns are used to contain the commodities for sale. The bucket is located between the storage columns and the pickup port and is configured to transport commodities between the storage columns and the pickup port. The bucket has a receiving bin which is rotatable arranged in the bucket and can be located at a receiving position or a dispensing position. When the bucket receives the commodities from the storage columns, the receiving bin is located at the receiving position; when the bucket is waiting for the user to pick up the commodity, the receiving bin is located at the dispensing position. After the receiving bin receives the commodities from the storage columns and the bucket moves to the pickup port, the control device first controls the gate for opening the pickup port, and then controls the receiving bin to rotate from the receiving position to the dispensing position, so that the user can pick up the commodity in the receiving bin through the pickup port.

However, the applicant finds that during the dispensing of the vending machine in the related art, after the gate opens the pickup port, if the user extends his hand through the pickup port to the bottom of the receiving bin when the receiving bin has not yet rotated from the receiving position to the dispensing position or it is rotating from the receiving position to the dispensing position, the receiving bin will squeeze the user's hand, and when it does so, it causes personal injury.

### SUMMARY

The following is a summary of the subject detailed in this document. This summary is not intended to limit the scope of the claims.

This application provides a vending machine and a merchandise dispensing method thereof to prevent the vending machine in the related art from squeezing a user's hand by a rotating receiving bin when the user extending his hand to the bottom of the receiving bin during the dispensing, so as to avoid personal injury to the user.

The embodiment of this application provides a merchandise dispensing method of the vending machine. The vending machine includes a cabinet body in which a bucket and storage columns for storage of commodities are arranged. A pickup port is arranged at the surface of the cabinet body and provided with a gate in an open position for opening the pickup port or in a closed position for blocking the pickup port. The bucket is located between the pickup port and the storage columns and includes a receiving bin with an opening and a baffle arranged on one side of the opening close to the pickup port. The receiving bin is configured to rotate between a receiving position and a dispensing position and receive commodities from the storage columns in the case where the receiving bin is located in the receiving position. The baffle is configured to be inserted into the pickup port in the case where the receiving bin is located in the dispensing position, and the opening is configured to face the pickup port in the case where the receiving bin is located in the dispensing position. The merchandise dispensing method of the vending machine includes the following: controlling the receiving bin to receive the commodity from a target storage column at the receiving position according to a purchase instruction of a user; driving the gate to move from the closed position to the open position and driving the receiving bin to rotate from the receiving position to the dispensing position in the case where the bucket containing the commodity for sale is located at the pickup port. The movement of the gate and the rotation of the receiving bin meet the following requirements: after the baffle of the receiving bin is inserted into the pickup port, the baffle and the gate move simultaneously, and the spacing between the baffle and the gate is always less than or equal to a first preset value which is set to prevent the user's finger from being inserted between the baffle and the gate.

In an embodiment, the gate moves from the closed position to the open position from top to bottom, and the spacing between the baffle and the gate is that between the intersection line of the planes where the baffle and the pickup port are located and the upper edge of the gate.

In an embodiment, driving the gate to move from the closed position to the open position and driving the receiving bin to rotate from the receiving position to the dispensing position in the case where the bucket containing the commodity for sale is located at the pickup port, including: driving the gate to move from the closed position to the open position in the case where the bucket containing the commodity for sale is located at the pickup port; driving the receiving bin to rotate from the receiving position to the dispensing position when the gate reaches a first preset position, so that after the baffle of the receiving bin is inserted into the pickup port, the baffle and the gate move simultaneously, and the spacing between the baffle and the gate is always less than or equal to the first preset value. The first preset position is located between the open position and the closed position.

In an embodiment, the gate moves from the closed position to the open position from top to bottom, when the gate moves to the first preset position, the height of the upper edge of the gate is equal to that of the upper edge of the baffle reaching the plane where the pickup port is located with the rotation of the receiving bin.

In an embodiment, the movement of the gate from the closed position to the open position and rotation of the receiving bin from the receiving position to the dispensing position also satisfy the following requirements: after the baffle of the receiving bin is inserted into the pickup port, the spacing between the baffle and the gate is always greater than or equal to a second preset value which is greater than zero and less than the first preset value.

In an embodiment, the movement of the gate and the rotation of the receiving bin are stopped when the gate reaches the open position.

In an embodiment, the merchandise dispensing method of the vending machine further includes: driving the bucket to the pickup port after the commodity for sale is fed into the bucket.

In an embodiment, the merchandise dispensing method of the vending machine further includes: recording the rotation angle of the receiving bin in the process of driving the receiving bin to rotate from the receiving position to the dispensing position; driving the receiving bin to rotate from the dispensing position to the receiving position and driving the gate to move from the open position to the closed position when the commodity for sale in the bucket is taken away; where the rotation angle for driving the receiving bin to rotate from the dispensing position to the receiving position is that recorded in the process of driving the receiving bin to rotate from the receiving position to the dispensing position.

In an embodiment, the rotation of the receiving bin from the dispensing position to the receiving position and the movement of the gate from the open position to the closed position meet the following requirements: when the baffle of the receiving bin is inserted into the pickup port, the baffle and the gate move simultaneously, and the spacing between the baffle and the gate is always less than or equal to the first preset value.

The embodiment of this application provides a vending machine, including a cabinet body and a control device, where a bucket and storage columns for storage of commodities are arranged in the cabinet body. A pickup port is arranged at the surface of the cabinet body and provided with a gate in an open position for opening the pickup port or in a closed position for blocking the pickup port. The bucket is located between the pickup port and the storage columns and includes a receiving bin with an opening and a baffle arranged on one side of the opening close to the pickup port. The receiving bin is configured to rotate between a receiving position and a dispensing position and receive commodities from the storage columns in the case where the receiving bin is located in the receiving position. The baffle is configured to be inserted into the pickup port in the case where the receiving bin is located in the dispensing position, and the opening is configured to face the pickup port in the case where the receiving bin is located in the dispensing position. The control device is configured to control a receiving bin to receive the commodity from a target storage column at the receiving position according to a purchase instruction of a user; drive the gate to move from the closed position to the open position and drive the receiving bin to rotate from the receiving position to the dispensing position in the case where the bucket containing the commodity for sale is located at the pickup port. The movement of the gate and the rotation of the receiving bin meet the following requirements: after the baffle of the receiving bin is inserted into the pickup port, the baffle and the gate move simultaneously, and the spacing between the baffle and the gate is always less than or equal to a first preset value which is set to prevent the user's finger from being inserted between the baffle and the gate.

In an embodiment, the gate moves from the closed position to the open position from top to bottom, and the spacing between the baffle and the gate is that between the intersection line of the planes where the baffle and the pickup port are located and the upper edge of the gate.

In an embodiment, the control device is configured to drive the gate to move from the closed position to the open position in the case where the bucket containing the commodity for sale is located at the pickup port and drive the receiving bin to rotate from the receiving position to the dispensing position when the gate reaches the first preset position, so that after the baffle of the receiving bin is inserted into the pickup port, the baffle and the gate move simultaneously, and the spacing between the baffle and the gate is always less than or equal to the first preset value. The first preset position is located between the open position and the closed position.

In an embodiment, the gate moves from the closed position to the open position from top to bottom. When the gate moves to the first preset position, the height of the upper edge of the gate is equal to that of the upper edge of the baffle reaching the plane where the pickup port is located with the rotation of the receiving bin.

In an embodiment, the movement of the gate from the closed position to the open position and the rotation of the receiving bin from the receiving position to the dispensing position also satisfy the following requirements: after the baffle of the receiving bin is inserted into the pickup port, the baffle and the gate move simultaneously and the spacing between the baffle and the gate is always greater than or equal to a second preset value which is greater than zero and less than the first preset value.

In an embodiment, the control device is configured to stop the movement of the gate and the receiving bin when the gate reaches the open position.

In an embodiment, the control device is also configured to drive the bucket to the pickup port after the commodity for sale is fed into the bucket.

In an embodiment, the control device is configured to record the rotation angle of the receiving bin in the process of driving the receiving bin to rotate from the receiving position to the dispensing position; the control device is also configured to drive the receiving bin to rotate from the dispensing position to the receiving position and drive the gate to move from the open position to the closed position when the commodity for sale in the bucket is taken away; where the rotation angle for driving the receiving bin to rotate from the dispensing position to the receiving position is that recorded in the process of driving the receiving bin to rotate from the receiving position to the dispensing position.

In an embodiment, the rotation of the receiving bin from the dispensing position to the receiving position and the movement of the gate from the open position to the closed position meet the following requirements: when the baffle of the receiving bin is inserted into the pickup port, the baffle and the gate move simultaneously, and the spacing between the baffle and the gate is always less than or equal to the first preset value.

Other aspects will become apparent after the drawings and the detailed description are read and understood.

### BRIEF DESCRIPTION OF DRAWINGS

Brief introduction is provided in the following for the drawings necessary in embodiment description to give a more clear description of the technical scheme in the embodiments of the present application. It should be understood that drawings below illustrate only some embodiments of the present application, and, therefore, should not be construed as a limitation of scope, and other related drawings may be acquired based on the said drawings by general technicians in the field without making any creative effort.

FIG. 1 is an external schematic structural diagram of a vending machine when a gate blocks a pickup port according to an embodiment of the present application;

FIG. 2 is an external schematic structural diagram of a vending machine when a gate opens a pickup port according to an embodiment of the present application;

FIG. 3 is an internal schematic structural diagram of a vending machine according to an embodiment of the present application;

FIG. 4 is a block diagram of a vending machine according to an embodiment of the present application;

FIG. 5 is a schematic structural diagram of a gate device of a vending machine according to an embodiment of the present application;

FIG. 6 is a schematic structural diagram of a bucket of a vending machine when a receiving bin is located at a receiving position according to an embodiment of the present application;

FIG. 7 is a schematic structural diagram of a bucket of a vending machine when a receiving bin is located at a dispensing position according to an embodiment of the present application;

FIG. 8 is a flow chart of a merchandise dispensing method of a vending machine according to an embodiment of the present application;

FIG. 9 is a local schematic structural diagram of a vending machine according to an embodiment of the present application;

FIG. 10 is a flow chart of a vending machine when a gate moves from a closed position to an open position and a receiving bin rotates from a receiving position to a dispensing position according to an embodiment of the present application; and

FIG. 11 is a flow chart of a merchandise dispensing method of another vending machine according to an embodiment of the present application;

In the figure: 010—vending machine; 100—cabinet; 110—cabinet body; 120—cabinet door; 130—pickup port; 140—gate device; 141—gate; 141a—first detecting member; 141b—second detecting member; 142—gate driving mechanism; 143—base frame; 200—storage device; 210—storage column; 211—commodity conveying mechanism; 300—delivering device; 310—bucket; 311—framework; 312—receiving bin; 312a—opening; 313—rotating shaft; 314—receiving bin driving mechanism; 315—baffle; 315a—first portion; 315b—second portion; 320—bucket driving mechanism; 321—horizontal driving mechanism; 322—vertical driving mechanism; 400—detecting device; 410—first sensor; 420—second sensor; 430—third sensor; 500—human-computer interaction device; 600—memory device; 700—control device.

### DETAILED DESCRIPTION

The technical solutions in the embodiments of this application will be clearly and completely described as follows by combining with the drawings herein. Obviously, the said embodiments are only some of rather than all of the embodiments of this application. Generally, the components of the embodiments of the present application, which are described and illustrated in the drawings herein, may be arranged and designed in various different configurations.

Therefore, the following detailed descriptions of embodiments of the present application in the drawings are not intended to limit the scope of the claimed application, but merely represent selected embodiments of the present application. Other embodiments based on the present application as acquired by general technicians in the field without making any creative effort also belong to the protection scope of the present application.

Note that similar numbers and letters refer to similar items in the following drawings. Therefore, once an item is defined in one drawing, the item will not be further defined or explained in the subsequent drawings.

It needs to be noted in the descriptions of embodiments of the present application that the terms “upper”, “lower”, “vertical”, “horizontal”, “inside”, “outside” and the like indicate an orientation or positional relationship based on those shown in the drawings or on how the inventive product is normally placed, and are used only for facilitating the description of the present application and for simplified description, not for indicating or implying that the target devices or components must have a special direction and be structured and operated at the special direction, thereby they cannot be understood as the restrictions to the present application. Moreover, the words “first”, “second” and “third” are only used for distinguishing descriptions, and cannot be understood as indicating or implying relative importance.

Besides, the terms “horizontal”, “vertical” and the like do not mean that the components are required to be absolutely horizontal or overhanging, but may be slightly inclined. For example, “horizontal” only means that its direction is more horizontal than “vertical”, which does not mean that the structure must be completely horizontal, but may be slightly inclined.

The technical solutions of the present application will be further explained below by combining with drawings and embodiments.

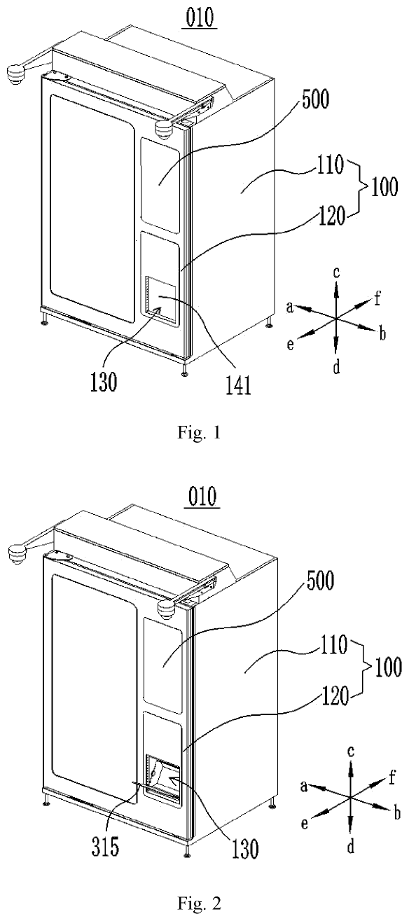

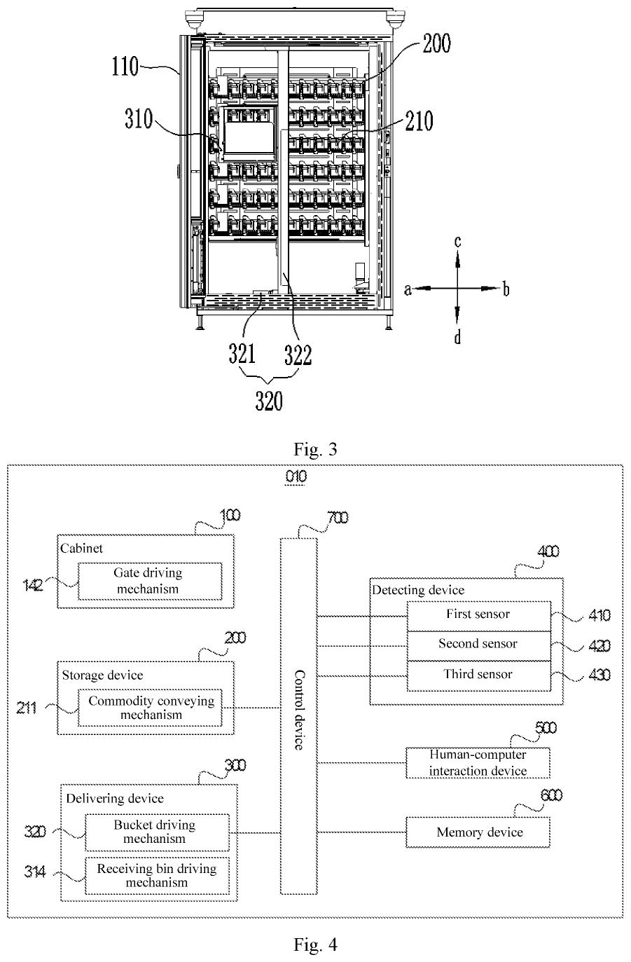

FIG. 1, FIG. 2, and FIG. 3 are schematic structural diagram of a vending machine 010 according to an embodiment of the present application, and FIG. 4 is a block diagram of a vending machine 010 according to the embodiment of the present application. The vending machine 010 according to the embodiment of the present application will be described below with reference to FIGS. 1-4.

As shown in FIGS. 1-4, the vending machine 010 of the embodiment includes a cabinet 100, a storage device 200, a delivering device 300, a detecting device 400, a human-computer interaction device 500, a memory device 600, and a control device 700.

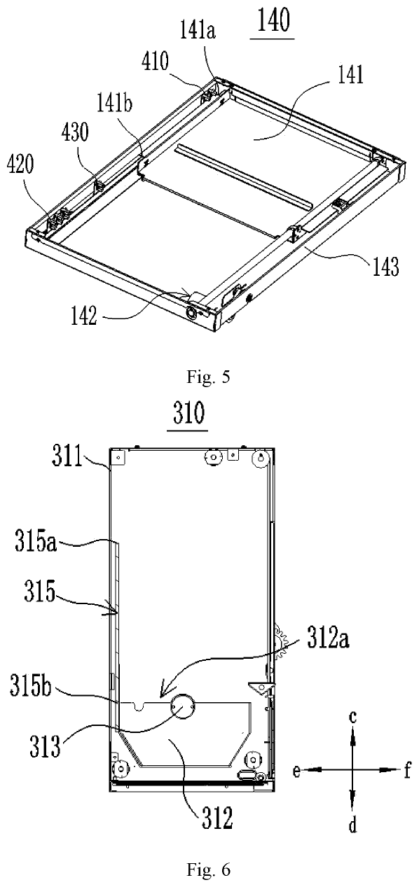

As shown in FIGS. 1 and 2, the cabinet 100 includes a cabinet body 110 and a cabinet door 120, where the cabinet body 110 is in a flexible connection with the cabinet door 120; the cabinet body 110 includes an opening (not shown), and the cabinet door 120 is movable relative to the opening of the cabinet body 110 to open or close the opening of the cabinet body 110. A pickup port 130 is arranged on the cabinet door 120 for users to take out the commodity. A gate device 140 is arranged at the pickup port 130. FIG. 5 is a schematic structural diagram of a gate device 140 of a vending machine 010 according to the embodiment of the present application. As shown in FIG. 5, the gate device 140 includes a gate 141, a gate driving mechanism 142 and a base frame 143. The base frame 143 is fixedly connected to the cabinet door 120, and the gate 141 is in transmission connection with the base frame 143 by the gate driving mechanism 142. Driven by the gate driving mechanism 142, the gate 141 is movable in a vertical direction (i.e., the direction indicated by arrow cd in FIGS. 1 and 2) relative to the pickup port 130 to reach a closed position, an open position or a first preset position. When the gate 141 is in the closed position, it is directly opposite to and blocks the pickup port 130; when the gate 141 is in the open position, it is located below the pickup port 130 and opens the pickup port 130; the first preset position is located between the closed position and the open position, and when the gate 141 is located in the first preset position, it blocks a portion of the pickup port 130. It should be noted that the specific form of the gate 141 is not limited by the embodiment, for example, the gate 141 move relative to the pickup port 130 in a left-right direction (i.e., the direction indicated by an arrow ab in FIGS. 1 and 2) according to other embodiments provided herein.

The storage device 200 is configured to contain commodities for sale. As shown in FIG. 3, the storage device 200 is arranged in the cabinet body 110 and relatively spaced from the cabinet door 120 (not shown in FIG. 3). The storage device 200 includes multiple storage columns 210 for accommodating commodities. Multiple storage columns 210 are arranged in M layers and N rows. The length of the storage columns 210 extends in the front-back direction (i.e., the direction indicated by an arrow of in FIGS. 1 and 2). The end of the storage columns 210 near the cabinet door 120 is provided with an outlet which is facing the cabinet door 120. A commodity conveying mechanism 211 is arranged in the storage columns 210, and the commodities contained in the storage columns 210 can be discharged from the outlet driven by the commodity conveying mechanism 211.

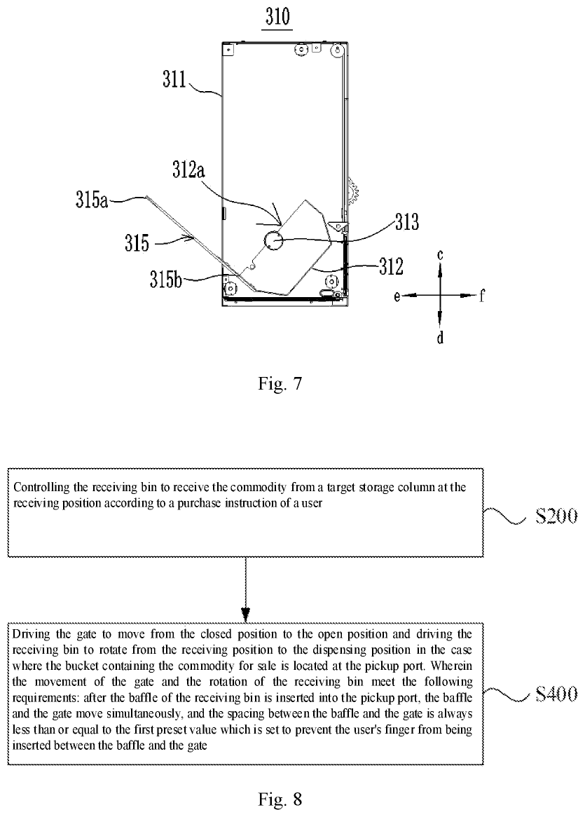

The delivering device 300 is configured to convey commodities between the storage device 200 and the pickup port 130. The delivering device 300 is located between the cabinet door 120 and the storage device 200. The delivering device 300 includes a bucket 310. FIGS. 6 and 7 are schematic structural diagram of a bucket 310 of a vending machine 010 according to the embodiment of the present application. As shown in FIGS. 6 and 7, the bucket 310 includes a frame 311 and a receiving bin 312, where the frame 311 has a commodity accommodation space throughout the bucket, and the space forms an inlet (i.e., the inlet of the bucket 310) and an outlet (i.e., the outlet of the bucket 310) opposite to each other on the end face of the frame 311. The receiving bin 312 is arranged in the commodity accommodation space and connected to the frame 311 by a rotating shaft 313, and it is rotatable relative to the frame 311 about the rotating shaft 313. As shown in FIG. 4, the bucket 310 also includes a receiving bin driving mechanism 314 which is in transmission connection with the receiving bin 312. Driven by the receiving bin driving mechanism 314, the receiving bin 312 is rotatable between a receiving position shown in FIG. 6 and a dispensing position shown in FIG. 7. The receiving bin 312 has an opening 312a, and as shown in FIG. 6, when the receiving bin 312 is in the receiving position, the opening 312a faces upward, and the receiving bin 312 can receive commodities from the storage columns 210. As shown in FIGS. 7 and 2, when receiving bin 312 is in the dispensing position, the opening 312a faces the pickup port 130, and the user can pick up the commodities from the receiving bin 312 through the opening 312a. The side of the opening 312a of the receiving bin 312 close to the pickup port 130 is provided with a baffle 315. When the receiving bin 312 is located in the receiving position, the baffle 315 is opposite to the storage columns 210 to prevent commodities from the storage columns 210 from falling into the outside of the bucket 310. When the receiving bin 312 is located in the dispensing position, the baffle 315 is inserted into the pickup port 130 to prevent commodities in the receiving bin 312 from being stuck between the cabinet door 120 and the receiving bin 312.

In an embodiment, the delivering device 300 also includes a bucket driving mechanism 320. As shown in FIG. 3, the bucket driving mechanism 320 includes a horizontal driving mechanism 321 and a vertical driving mechanism 322, where the horizontal driving mechanism 321 includes a horizontal bracket (not shown in the figure) and a first power assembly (not shown in the figure), and the vertical driving mechanism 322 includes a vertical bracket (not shown in the figure) and a second power assembly (not shown in the figure). The bucket 310 is in transmission connection with the vertical bracket, and the second power assembly is arranged between the bucket 310 and the vertical bracket to drive the bucket 310 to move up and down on the vertical bracket. The vertical bracket is in transmission connection with the horizontal bracket, and the first power assembly is arranged between the vertical bracket and the horizontal bracket to drive the vertical bracket and the bucket 310 to move in the left-right direction on the horizontal bracket. In this way, the bucket driving mechanism 320 drives the bucket 310 to move up and down, or to move left and right, or to move both vertically and horizontally at the same time, so that the inlet of the bucket 310 is opposite to the outlet of any one of the storage columns 210, or the outlet of the bucket 310 is opposite to the pickup port 130. When the inlet of the bucket 310 is opposite to the outlet of any of the storage columns 210, the commodities in the storage columns 210 can be fed into the bucket 310; when the outlet of the bucket 310 is opposite to the pickup port 130, the user can pick up the commodity in the bucket 310 through the pickup port 130.

The detecting device 400 is configured to detect the position of the gate 141. The detecting device 400 includes a first sensor 410, a second sensor 420, and a third sensor 430, where the first sensor 410 is configured to detect whether the gate 141 is in the closed position, the second sensor 420 is configured to detect whether the gate 141 is in the open position, the third sensor 430 is configured to detect whether the gate 141 is in the first preset position. As shown in FIG. 5, in this embodiment, the first sensor 410, the second sensor 420, and the third sensor 430 are fixedly connected to the base frame 143 of the gate device 140, and the first sensor 410, the third sensor 430, and the second sensor 420 are sequentially arranged on the movement path of the gate 141 from top to bottom. As shown in FIG. 5, the gate 141 is provided with a first detecting member 141a and a second detecting member 141b. When the gate 141 is in the closed position, the first detecting member 141a is coupled with the first sensor 410, and the first sensor 410 sends a first signal; when the gate 141 is not in the closed position, the first detecting member 141a is separated from the first sensor 410, and the first sensor 410 sends a second signal. Therefore, whether the gate 141 is in the closed position can be determined by detecting the signal sent from the first sensor 410. When the gate 141 is in the open position, the second detecting member 141b is coupled with the second sensor 420, and the second sensor 420 sends a third signal; when the gate 141 is not in the open position, the second detecting member 141b is separated from the second sensor 420, and the second sensor 420 sends a fourth signal. Therefore, whether the gate 141 is in the open position can be determined by detecting the signal sent by the second sensor 420. The third sensor 430 is located between the first sensor 410 and the second sensor 420. When the gate 141 is in the closed position, the second detecting member 141b is separated from the third sensor 430, and the third sensor 430 sends a fifth signal. During the movement of the gate 141 from the closed position to the open position, when the gate 141 moves from top to bottom, the second detecting member 141b gradually approaches the third sensor 430; when the gate 141 reaches the first preset position, the second detecting member 141b is coupled with the third sensor 430, and the third sensor 430 sends a sixth signal. Therefore, whether the gate 141 reaches the first preset position can be determined by detecting the signal sent from the third sensor 430.

The human-computer interaction device 500 is configured to complete information interaction between the user and the vending machine 010, for example, the human-computer interaction device 500 is configured to receive a purchase instruction input by the user, output operation information to the user, and the like. As shown in FIGS. 1 and 2, in this embodiment, the human-computer interaction device 500 is arranged on the cabinet door 120.

The memory device 600 is configured to store the control program of the vending machine 010 and the data and variables generated during the process when the program is running. For example, the storage device 600 is configured to store a first preset value S1 and a second preset value S2, where the first preset value S1 is the maximum value of the spacing between the baffle 315 and the gate 141 after the baffle 315 of the receiving bin 312 is inserted into the pickup port 130 in the process of dispensing commodities of the vending machine 010. The spacing between the baffle 315 and the gate 141 refers to, in the plane (hereinafter referred to as a first plane) in which the pickup port 130 is located, the distance between an intersection line (hereinafter referred to as a first intersection line) of the baffle 315 and the first plane and the upper edge of the gate 141. The first preset value S1 is set to prevent the user's finger from being inserted between the baffle 315 and the gate 141, that is, when the spacing between the baffle 315 and the gate 141 is less than or equal to the first preset value S1, the user's finger cannot protrude under the receiving bin 312 through the gap between the baffle 315 and the gate 141. The second preset value S2 is the minimum value of the spacing between the baffle 315 and the gate 141 after the commodities are dispensed by the vending machine 010 and the baffle 315 of the receiving bin 312 is inserted into the pickup port 130. The second preset value S2 is set to be greater than zero and less than the first preset value S1. For another example, the memory device 600 is configured to store a first preset angle A1, where the first preset angle A1 is the angle at which the receiving bin 312 rotates from the receiving position to the dispensing position.

The control device 700 is electrically connected with the storage device 200, the delivering device 300, the detecting device 400, the human-computer interaction device 500, and the memory device 600 and configured to control the storage device 200, the delivering device 300, the detecting device 400, the human-computer interaction device 500 and the storage device 600 of the vending machine 010. For example, the control device 700 is configured to acquire a purchase instruction input by the user through the human-computer interaction device 500; determine the target storage column 210 containing the commodities for sale according to the purchase instruction; control the bucket driving mechanism 320 of the delivering device 300 to drive the bucket 310 to the target storage column 210; control the commodity conveying mechanism 211 of the target storage column 210 to convey the commodity to be purchased by the user from the target storage column 210 to the bucket 310, and control the bucket driving mechanism 320 to drive the bucket 310 to the pickup port 130. The control device 700 is further configured to control the gate driving mechanism 142 to drive the gate 141 to move from the closed position to the open position and control the receiving bin driving mechanism 314 to drive the receiving bin 312 to rotate from the receiving position to the dispensing position in the case where the bucket 310 containing the commodity for sale is located at the pickup port 130, where the movement of the gate 141 and the rotation of the receiving bin 312 meet the following requirements: after the baffle 315 of the receiving bin 312 is inserted into the pickup port 130, the baffle 315 and the gate 141 move simultaneously, and the spacing between the baffle 315 and the gate 141 is always less than or equal to the first preset value S1 which is set to prevent the user's finger from being inserted between the baffle 315 and the gate 141. In an embodiment, the control device 700 is configured to stop the movement of the gate 141 and the receiving bin 312 when the gate 141 reaches the open position. In an embodiment, the control device 700 is also configured to record the rotation angle of the receiving bin 312 in the process of driving the receiving bin 312 to rotate from the receiving position to the dispensing position. In an embodiment, the control device 700 is also configured to control the receiving bin driving mechanism 314 to drive the receiving bin 312 to rotate from the dispensing position to the receiving position and control the gate driving mechanism 142 to drive the gate 141 to move from the open position to the closed position when the commodity for sale in the bucket 310 is taken away. In an embodiment, the rotation angle for driving the receiving bin 312 to rotate from the dispensing position to the receiving position is that recorded in the process of driving the receiving bin 312 to rotate from the receiving position to the dispensing position.

FIG. 8 is a flow chart of a merchandise dispensing method of a vending machine according to an embodiment of the present application. The method can be implemented by the control device 700 of the vending machine 010, as shown in FIG. 4. As shown in FIG. 8, the method includes Steps S200 and S400.

Step S200: controlling the receiving bin to receive the commodity from a target storage column at the receiving position according to a purchase instruction of a user.

Taking the vending machine 010 according to the embodiment of the present application as an example, the human-computer interaction device 500 receives a purchase instruction input by a user; the control device 700 determines the commodity to be purchased by the user according to the purchase instruction, that is, the commodity for sale, and further determines the storage column 210 containing the commodity for sale, that is, the target storage column 210. The control device 700 controls the bucket driving mechanism 320 of the delivering device 300 to drive the bucket 310 to the target storage column 210, and controls the commodity conveying mechanism 211 in the target storage column 210 to convey the commodity for sale into the bucket 310. When the bucket 310 receives the commodity from the target storage column 210, the receiving bin 312 is located at the receiving position to receive the commodity for sale conveyed from the target storage column 210.

Step S400: driving the gate to move from the closed position to the open position and driving the receiving bin to rotate from the receiving position to the dispensing position in the case where the bucket containing the commodity for sale is located at the pickup port. The movement of the gate and the rotation of the receiving bin meet the following requirements: after the baffle of the receiving bin is inserted into the pickup port, the baffle and the gate move simultaneously, and the spacing between the baffle and the gate is always less than or equal to the first preset value which is set to prevent the user's finger from being inserted between the baffle and the gate.

Taking the vending machine 010 according to the embodiment of the present application as an example, the control device 700 controls the gate driving mechanism 142 to drive the gate 141 to move from the closed position to the open position from top to bottom and controls the receiving bin driving mechanism 314 to drive the receiving bin 312 to rotate from the receiving position to the dispensing position in the case where the bucket 310 containing the commodity for sale is located at the pickup port 130. The movement of the gate 141 and the rotation of the receiving bin 312 meet the following requirements: after the baffle 315 of the receiving bin 312 is inserted into the pickup port 130, the baffle 315 and the gate 141 move simultaneously, and the spacing between the baffle 315 and the gate 141 is always less than or equal to the first preset value. The spacing between the baffle 315 and the gate 141 refers to, in the plane (hereinafter referred to as a first plane) in which the pickup port 130 is located, the distance between an intersection line (hereinafter referred to as a first intersection line) of the baffle 315 and the first plane and the upper edge of the gate 141. The first preset value S1 is set to prevent the user's finger from being inserted between the baffle 315 and the gate 141, that is, when the spacing between the baffle 315 and the gate 141 is less than or equal to the first preset value S1, the user's finger cannot protrude under the receiving bin 312 through the gap between the baffle 315 and the gate 141.

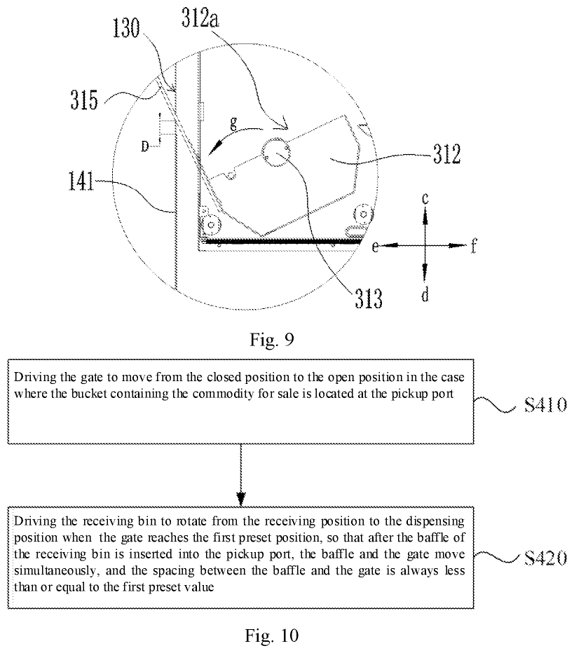

FIG. 9 is a local schematic structural diagram of the vending machine 010 according to an embodiment of the present application. As shown in FIG. 9, the gate 141 moves from top to bottom in the direction indicated by an arrow d when moving from the closed position to the open position; the receiving bin 312 rotates counterclockwise as shown by an arrow g when rotating from the receiving position to the dispensing position. As the receiving bin 312 rotates, a first portion 315a of the baffle 315 gradually reaches the pickup port 130 and is gradually inserted through the first plane into the pickup port 130, and as the receiving bin 312 further rotates, the first intersection line moves from top to bottom on the first plane in the direction indicated by an arrow d. The movement of the gate 141 and the rotation of the receiving bin 312 meet the following requirements: after the baffle 315 of the receiving bin 312 is inserted into the pickup port 130, the baffle 315 and the gate 141 move simultaneously, and the first intersection line is located above the gate 141 on the first plane, and the distance D between the first intersection line and the gate 141 is always less than or equal to the first preset value S1, where the first preset value S1 can be obtained in advance through experiments or tests and stored in the memory device 600, and set to prevent the user's finger from being inserted between the baffle 315 and the gate 141. In an embodiment, the first preset value is less than 1 cm.

In an embodiment, the control device 700, in accordance with the signal sent by the detecting device 400, controls the gate driving mechanism 142 to drive the gate 141 to move from the closed position to the open position, where, the control device 700 detects the signal sent by the second sensor 420 during the movement of the gate 141 and determines whether the gate 141 reaches the open position in accordance with the signal sent by the second sensor 420. For example, when it is detected that the signal sent by the second sensor 420 changes from the fourth signal to the third signal, the control device 700 determines that the gate 141 reaches the open position, and then controls the gate driving mechanism 142 to stop driving the gate 141 to move. In an embodiment, after the baffle 315 of the receiving bin 312 is inserted into the pickup port 130, the baffle 315 and the gate 141 move simultaneously; when the gate 141 reaches the open position, the control device 700 determines that the receiving bin 312 reaches the dispensing position, and controls the receiving bin driving mechanism 314 to stop driving the receiving bin 312 to rotate. Of course, in other embodiments of the present application, the control device 700 may also control the receiving bin driving mechanism 314 to drive the receiving bin 312 to rotate the first preset angle A1 from the receiving position to the dispensing position, where the first preset angle A1 can be obtained in advance through experiments or tests and stored in the memory device 600. For example, the first preset angle is 45 degrees, and the first preset angle A1 meets the following requirement: the receiving bin 312 does not interfere with the gate 141 during rotation from the receiving position to the dispensing position.

FIG. 10 is a flow chart of a vending machine 010 when a gate 141 moves from a closed position to an open position and a receiving bin 312 rotates from a receiving position to a dispensing position according to an embodiment of the present application. As shown in FIG. 10, Step S400 may include Step S410 and Step S420 according to an embodiment of this application.

Step S410: driving the gate to move from the closed position to the open position in the case where the bucket containing the commodity for sale is located at the pickup port.

The control device 700 controls the gate driving mechanism 142 to drive the gate 141 to move from the closed position to the open position in the case where the bucket 310 containing the commodity for sale is located at the pickup port 130. For the vending machine 010 according to the embodiment of the present application, the control device 700 controls the gate driving mechanism 142 to drive the gate 141 to move from the closed position to the open position from top to bottom.

Step S420: driving the receiving bin to rotate from the receiving position to the dispensing position when the gate reaches the first preset position, so that after the baffle of the receiving bin is inserted into the pickup port, the baffle and the gate move simultaneously, and the spacing between the baffle and the gate is always less than or equal to the first preset value.

The control device 700 determines whether the gate 141 reaches the first preset position in accordance with the signal sent by the detecting device 400 when controlling the gate driving mechanism 142 to drive the gate 141 to move from the closed position to the open position. In an embodiment, the control device 700 detects the signal sent by the third sensor 430 during the movement of the gate 141 and determines whether the gate 141 reaches the first preset position in accordance with the signal sent by the third sensor 430. For example, when it is detected that the signal sent by the third sensor 430 changes from the fifth signal to the sixth signal, the control device 700 determines that the gate 141 reaches the first preset position. At this time, the control device 700 controls the receiving bin driving mechanism 314 to drive the receiving bin 312 to rotate from the receiving position to the dispensing position, so that after the baffle 315 is inserted into the pickup port 130, the baffle 315 and the gate 141 move simultaneously, and the distance D between the baffle 315 and the gate 141 is always less than or equal to the first preset value.

The first preset position can be obtained in advance through experiments or tests. For example, in this embodiment, the control device 700 controls the gate driving mechanism 142 to drive the gate 141 to move from the closed position to the open position from top to bottom. When the gate 141 moves to the first preset position, the height of the upper edge of the gate 141 is equal to the height of the upper edge of the baffle 315 when the upper edge of the baffle 315 rotates with the receiving bin 312 and reaches the plane of the pickup port 130. In an embodiment, when the bucket 310 is located at the pickup port 130 and the receiving bin 312 is in the receiving position, the baffle 315 is adjacent to the pickup port 130; when the receiving bin 312 starts to rotate from the receiving position to the dispensing position, the first portion 315a of the baffle 315 first reaches the pickup port 130. Given the height of the first intersection line when the first portion 315a of the baffle 315 reaches the pickup port 130 is H, the first preset position can be set to meet the following requirement: when the gate 141 reaches the first preset position, the height of the upper edge of the gate 141 is H. When the gate 141 reaches the first preset position, the control device 700 controls the receiving bin 312 to rotate from the receiving position to the dispensing position. Since the gate 141 continues to move downward at this time, the upper edge of the gate 141 is located below the first intersection line when the first portion 315a of the baffle 315 reaches the pickup port 130. The manufacturer of the vending machine 010 may preset the position of the third sensor 430 according to the height H and the first preset value S1, so that after it is detected that the gate 141 reaches the first preset position according to the signal sent by the third sensor 430 and the receiving bin 312 is controlled to rotate from the receiving position to the dispensing position, when the first portion 315a of the baffle 315 reaches the pickup port 130, the distance D between the baffle 315 and the gate 141 is equal to or less than the first preset value S1. Of course, in other embodiments of the present application, it is also possible to record the movement distance of the gate 141 during its movement from the closed position to the open position. When the movement distance of the gate 141 reaches the preset value, it is determined that the gate 141 reaches the first preset position.

It should be noted that since the movement of the gate 141 from the closed position to the open position is linear but circular motion occurs when the baffle 315 moves during the rotation of the receiving bin 312 from the receiving position to the dispensing position, the movement speed of the gate 141 can be adjusted during its movement, or the rotation speed of the receiving bin 312 can be adjusted during its rotation, or both the movement speed of the gate 141 during its movement and the rotation speed of the receiving bin 312 during its rotation can be adjusted, so that the distance D between the baffle 315 and the gate 141 is always less than or equal to the first preset value S1. In an embodiment, as shown in FIG. 9, the baffle 315 rotates about the rotating shaft 313 in the case where the receiving bin 312 rotates from the receiving position to the dispensing position; since the position of the first intersection line on the baffle 315 gradually moves from the first portion 315a to the second portion 315b when the baffle 315 rotates about the rotating shaft 313, that is, the distance between the first intersection line and the rotating shaft 313 is getting closer and closer, the speed of movement of the first intersection line on the first plane will gradually decrease if the rotation speed of the receiving bin 312 is constant. Therefore, in order to ensure that the distance D between the baffle 315 and the gate 141 remains unchanged, it is possible to gradually increase the rotation speed of the receiving bin 312 or decrease the movement speed of the gate 141, or gradually increase the rotation speed of the receiving bin 312 and decrease the movement speed of the gate 141 during the simultaneous movement of the baffle 315 and the gate 141.

It should be noted that the movement of the gate 141 of the vending machine 010 from the closed position to the open position and the rotation of the receiving bin 312 from the receiving position to the dispensing position meet the following requirements: after the baffle 315 of the receiving bin 312 is inserted into the pickup port 130, the baffle 315 and the gate 141 move simultaneously, and the distance D between the baffle 315 and the gate 141 is always less than or equal to the first preset value S1. The method for executing the movement of the gate 141 and the rotation of the receiving bin 312 is not limited by the method shown in FIG. 10. For example, it may be first controlling the gate 141 to move from the closed position to the open position and then controlling the receiving bin 312 to rotate from the receiving position to the dispensing position as described in the embodiment of the present application; it may also be first controlling the receiving bin 312 to rotate from the receiving position to the dispensing position and then controlling the gate 141 to move from the closed position to the open position in the case where the receiving bin 312 rotates a set angle; it may also be starting the movement of the gate 141 from the closed position to the open position and the rotation of the receiving bin 312 from the receiving position to the dispensing position simultaneously. In addition, the movement forms of the gate 141 and the receiving bin 312 are not limited by the embodiments of the present application. For example, the gate 141 may move between the closed position and then open position in the left-right direction; a clamping device may be provided in the receiving bin 312 to fix the commodity for sale in the receiving bin 312, and the receiving bin 312 may be rotated from the receiving position to the dispensing position about a rotating shaft set vertically.

In the merchandise dispensing method of the vending machine according to the embodiment, driving the gate to move from the closed position to the open position and driving the receiving bin to rotate from the receiving position to the dispensing position in the case where the bucket containing the commodity for sale is located at the pickup port, where the movement of the gate and the rotation of the receiving bin meet the following requirements: after the baffle of the receiving bin is inserted into the pickup port, the baffle and the gate move simultaneously, and the spacing between the baffle and the gate is always less than or equal to the first preset value. Since the first preset value is set to prevent the user's finger from being inserted between the baffle and the gate, the merchandise dispensing method of the vending machine according to the embodiment can prevent the user from putting his hand under the receiving bin through the gap between the baffle and the gate when the vending machine dispenses commodities, so as to avoid the user's hand being squeezed by the receiving bin during its rotation. Therefore, it can prevent the vending machine in the related art from squeezing a user's hand by a rotating receiving bin when the user extending his hand to the bottom of the receiving bin during the dispensing, so as to avoid personal injury to the user.

In an embodiment, the movement of the gate from the closed position to the open position and rotation of the receiving bin from the receiving position to the dispensing position also satisfy the following requirements: after the baffle of the receiving bin is inserted into the pickup port, the baffle and the gate move simultaneously and the distance D between the baffle and the gate is always greater than or equal to the second preset value S2 which is set to be greater than zero and less than the first preset value S1. Similarly, the second preset value S2 can be obtained in advance through experiments or tests and stored in the memory device 600. As the spacing between the baffle and the gate is always greater than the second preset value during the movement of the gate from the closed position to the open position and the rotation of the receiving bin from the receiving position to the dispensing position, the baffle and the gate are not in contact during the process, thus avoiding abrasion or scratches caused by the contact between the baffle and the gate.

The vending machine according to the embodiment of the present application can also avoid the above situation, as the control device included in the vending machine can be used to control the vending machine to realize the above merchandise dispensing method.

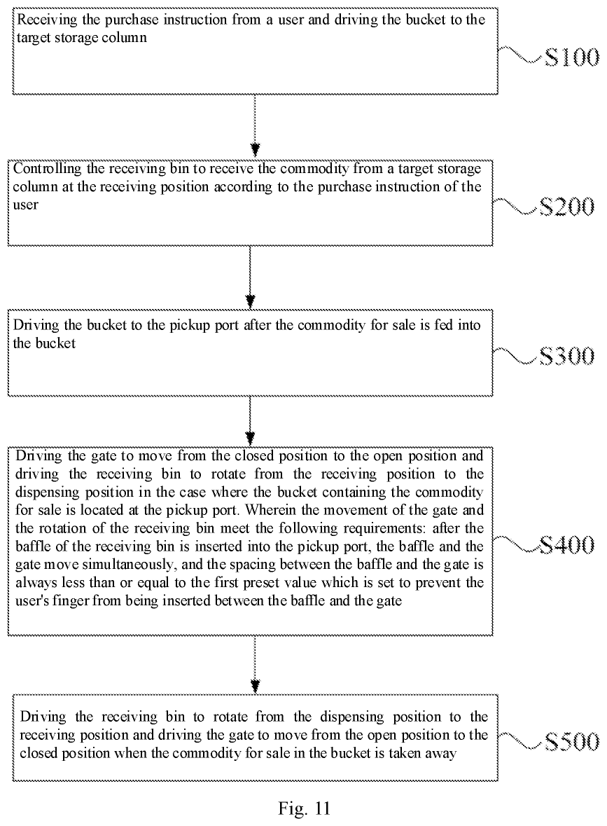

FIG. 11 is a flow chart of another merchandise dispensing method of vending machine according to an embodiment of the present application. The embodiment can be used as an example of the embodiment shown in FIG. 8. As shown in FIG. 11, this embodiment differs from the embodiment shown in FIG. 8 in that the merchandise dispensing method further includes Step S100 before Step S200, Step S300 before Step S400, and Step S500 after Step S400.

Step S100: receiving the purchase instruction from a user and driving the bucket to the target storage column.

Taking the vending machine 010 according to the embodiment of the present application as an example, the control device 700 receives a purchase instruction input by a user through the human-computer interaction device 500, determines the commodity to be purchased by the user according to the purchase instruction, that is, the commodity for sale, and further determines the storage column 210 containing the commodity for sale, that is, the target storage column 210. The control device 700 then controls the bucket driving mechanism 320 of the delivering device 300 to drive the bucket 310 to the target storage column 210. When the bucket 310 receives the commodity from the target storage column 210, the receiving bin 312 is located at the receiving position to receive the commodity for sale conveyed from the target storage column 210.

Step S300: driving the bucket to the pickup port after the commodity for sale is fed into the bucket.

Taking the vending machine 010 according to the embodiment of the present application as an example, the bucket 310 is provided with a commodity detecting mechanism. When the commodity detecting mechanism detects that the commodity for sale is conveyed to the bucket 310, the control device 700 controls the bucket driving mechanism 320 of the delivering device 300 to drive the bucket 310 to the pickup port 130. During the movement of the bucket 310, the receiving bin 312 is located at the receiving position, and the baffle 315 prevents the commodity in the receiving bin 312 from falling out of the receiving bin 312, thus ensuring stability in the conveying of the commodity.

Step S500: driving the receiving bin to rotate from the dispensing position to the receiving position and driving the gate to move from the open position to the closed position when the commodity for sale in the bucket is taken away.

Taking the vending machine 010 according to the embodiment of the present application as an example, the control device 700 controls the receiving bin driving mechanism 314 to drive the receiving bin 312 to rotate from the dispensing position to the receiving position and controls the gate driving mechanism 142 to drive the gate 141 to move from the open position to the closed position when it determines that the commodities for sale in the bucket 310 are taken away according to the commodity detecting mechanism in the bucket 310.

In an embodiment, the control device 700 controls the receiving bin 312 to rotate from the dispensing position to the receiving position by controlling the receiving bin driving mechanism 314 to drive the receiving bin 312 to rotate a preset angle. The preset angle is the angle at which the receiving bin 312 rotates from the receiving position to the dispensing position, for example, the first preset angle A1. In an embodiment, based on Step S400 according to the embodiment shown in FIG. 8, Step S400 according to the embodiment shown in FIG. 11 may further include recording the rotation angle of the receiving bin 312 in the case where the receiving bin 312 rotates from the receiving position to the dispensing position, and the recorded rotation angle may be used as a preset angle in the case where the receiving bin 312 rotates from the dispensing position to the receiving position after the commodity is taken away. When controlling the receiving bin 312 to rotate from the dispensing position to the receiving position by driving the receiving bin 312 to rotate a preset angle, the control device 700, in accordance with the signal sent by the detecting device 400, controls the gate driving mechanism 142 to drive the gate 141 to move from the open position to the closed position, where, the control device 700 detects the signal sent by the first sensor 410 during the movement of the gate 141 and determines whether the gate 141 reaches the closed position in accordance with the signal sent by the first sensor 410. For example, when it is detected that the signal sent by the first sensor 410 changes from the second signal to the first signal, the control device 700 determines that the gate 141 reaches the closed position, and at this time, the control device 700 controls the gate driving mechanism 142 to stop the movement of the gate 141.

In an embodiment, the rotation of the receiving bin 312 from the dispensing position to the receiving position and the movement of the gate 141 from the open position to the closed position from bottom to top meet the following requirements: when the baffle 315 of the receiving bin 312 is inserted into the pickup port 130, the baffle 315 and the gate 141 move simultaneously, and the distance D between the baffle 315 and the gate 141 is always less than or equal to the first preset value S1. The configuration ensures that the user cannot put his hand under the receiving bin through the gap between the baffle and the gate in the process of closing the gate of the vending machine, so as to avoid squeezing the hand of the user during the closing process, thus further avoiding personal injury to the user.

1. A merchandise dispensing method of a vending machine, wherein the vending machine comprises a cabinet body in which a bucket and storage columns for storage of commodities are arranged; a pickup port is arranged at the surface of the cabinet body and provided with a gate in an open position for opening the pickup port or in a closed position for blocking the pickup port; the bucket is located between the pickup port and the storage columns and comprises a receiving bin with an opening and a baffle arranged on one side of the opening close to the pickup port; the receiving bin is configured to rotate between a receiving position and a dispensing position and receive commodities from the storage columns in the case where the receiving bin is located in the receiving position; the baffle is configured to be inserted into the pickup port in the case where the receiving bin is located in the dispensing position, and the opening is configured to face the pickup port in the case where the receiving bin is located in the dispensing position; the merchandise dispensing method, comprising:
controlling the receiving bin to receive the commodity from a target storage column at the receiving position according to a purchase instruction of a user;
driving the gate to move from the closed position to the open position and driving the receiving bin to rotate from the receiving position to the dispensing position in the case where the bucket containing the commodity for sale is located at the pickup port;
wherein the movement of the gate and the rotation of the receiving bin meet the following requirements: after the baffle of the receiving bin is inserted into the pickup port, the baffle and the gate move simultaneously, and the spacing between the baffle and the gate is always less than or equal to a first preset value which is set to prevent the user's finger from being inserted between the baffle and the gate.

2. The merchandise dispensing method of the vending machine according to claim 1, wherein the driving the gate to move from the closed position to the open position and driving the receiving bin to rotate from the receiving position to the dispensing position in the case where the bucket containing the commodity for sale is located at the pickup port comprises:
driving the gate to move from the closed position to the open position in the case where the bucket containing the commodity for sale is located at the pickup port;
driving the receiving bin to rotate from the receiving position to the dispensing position when the gate reaches a first preset position, so that after the baffle of the receiving bin is inserted into the pickup port, the baffle and the gate move simultaneously, and the spacing between the baffle and the gate is always less than or equal to the first preset value, wherein the first preset position is located between the open position and the closed position.

3. The merchandise dispensing method of the vending machine according to claim 1, wherein
the movement of the gate from the closed position to the open position and the rotation of the receiving bin from the receiving position to the dispensing position also satisfy the following requirements: after the baffle of the receiving bin is inserted into the pickup port, the spacing between the baffle and the gate is always greater than or equal to a second preset value which is greater than zero and less than the first preset value.

4. The merchandise dispensing method of the vending machine according to claim 1, wherein
the movement of the gate and the rotation of the receiving bin is stopped when the gate reaches the open position.

5. The merchandise dispensing method of the vending machine according to claim 1, comprising:
driving the receiving bin to rotate from the dispensing position to the receiving position and driving the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

6. A vending machine, comprising a cabinet body and a control device, wherein a bucket and storage columns for storage of commodities are arranged in the cabinet body; a pickup port is arranged at the surface of the cabinet body and provided with a gate in an open position for opening the pickup port or in a closed position for blocking the pickup port; the bucket is located between the pickup port and the storage columns and comprises a receiving bin with an opening and a baffle arranged on one side of the opening close to the pickup port; the receiving bin is configured to rotate between a receiving position and a dispensing position and receive commodities from the storage columns in the case where the receiving bin is located in the receiving position; the baffle is configured to be inserted into the pickup port in the case where the receiving bin is located in the dispensing position, and the opening is configured to face the pickup port in the case where the receiving bin is located in the dispensing position; wherein
the control device is configured to control the receiving bin to receive commodity from a target storage column at the receiving position according to a purchase instruction of a user, and drive the gate to move from the closed position to the open position and drive the receiving bin to rotate from the receiving position to the dispensing position in the case where the bucket containing the commodity for sale is located at the pickup port;
the movement of the gate and the rotation of the receiving bin meet the following requirements: after the baffle of the receiving bin is inserted into the pickup port, the baffle and the gate move simultaneously, and the spacing between the baffle and the gate is always less than or equal to the first preset value which is set to prevent the user's finger from being inserted between the baffle and the gate.

7. The vending machine according to claim 6, wherein
the control device is configured to drive the gate to move from the closed position to the open position in the case where the bucket containing the commodity for sale is located at the pickup port, drive the receiving bin to rotate from the receiving position to the dispensing position when the gate reaches a first preset position, so that after the baffle of the receiving bin is inserted into the pickup port, the baffle and the gate move simultaneously, and the spacing between the baffle and the gate is always less than or equal to the first preset value, wherein the first preset position is located between the open position and the closed position.

8. The vending machine according to claim 6, wherein
the movement of the gate from the closed position to the open position and rotation of the receiving bin from the receiving position to the dispensing position also satisfy the following requirements: after the baffle of the receiving bin is inserted into the pickup port, the spacing between the baffle and the gate is always greater than or equal to a second preset value which is greater than zero and less than the first preset value.

9. The vending machine according to claim 6, wherein
the control device is configured to stop the movement of the gate and the rotation of the receiving bin when the gate reaches the open position.

10. The vending machine according to claim 6, wherein,
the control device is configured to drive the receiving bin to rotate from the dispensing position to the receiving position and drive the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

11. The merchandise dispensing method of the vending machine according to claim 2, comprising:
driving the receiving bin to rotate from the dispensing position to the receiving position and driving the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

12. The merchandise dispensing method of the vending machine according to claim 3, comprising:
driving the receiving bin to rotate from the dispensing position to the receiving position and driving the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

13. The merchandise dispensing method of the vending machine according to claim 4, comprising:
driving the receiving bin to rotate from the dispensing position to the receiving position and driving the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

14. The vending machine according to claim 7, wherein,
the control device is configured to drive the receiving bin to rotate from the dispensing position to the receiving position and drive the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

15. The vending machine according to claim 8, wherein,
the control device is configured to drive the receiving bin to rotate from the dispensing position to the receiving position and drive the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.

16. The vending machine according to claim 9, wherein,
the control device is configured to drive the receiving bin to rotate from the dispensing position to the receiving position and drive the gate to move from the open position to the closed position when the commodity for sale in the bucket is taken away;
wherein the rotation of the receiving bin from the dispensing position to the receiving position and the movement of the gate from the open position to the closed position meet the following requirements: in the case where the baffle of the receiving bin is inserted into the pickup port, the baffle and the gate move simultaneously, and the spacing between the baffle and the gate is always less than or equal to the first preset value.
